(19) United States
(12) Patent Application Publication
(10) Pub. No.: US 2013/0304541 A1
(43) Pub. Date: Nov. 14, 2013

(54) CONSUMER-INITIATED DEMAND-DRIVEN INTERACTIVE MARKETPLACE

(71) Applicant: Ripple Commerce, Inc., Birmingham, MI (US)

(72) Inventors: Jeffrey Sloan, Birmingham, MI (US); Christopher Cameron, Royal Oak, MI (US); Jason Aubrey, Ann Arbor, MI (US); Kevin Bui, Ann Arbor, MI (US)

(21) Appl. No.: 13/891,999

(22) Filed: May 10, 2013

Related U.S. Application Data
(60) Provisional application No. 61/646,054, filed on May 11, 2012.
(60) Provisional application No. 61/750,619, filed on Jan. 9, 2013.

(51) Int. Cl. G06Q 30/02

(52) U.S. Cl. CPC G06Q 30/0202
USPC 705/7.31

(57) ABSTRACT

Disclosed herein are systems and methods for managing consumer demand in an online marketplace. In one aspect, a method for managing consumer initiated demand in an online marketplace comprises: receiving a first request for a product or service from a first consumer; identifying one of a plurality of categories as corresponding to the first request; assigning the first request to the identified category; receiving at least one additional request for a product or service from a second consumer and assigning the at least one additional request to the identified category; determining, using a processor, a demand for the identified category based at least on the number of requests assigned to the identified category; and selectively generating a merchant notification for at least one merchant based on the determined demand for the identified category.

### CROSS REFERENCE TO RELATED APPLICATIONS

This application claims priority to U.S. Provisional Patent Application No. 61/646,054, filed May 11, 2012, and to U.S. Provisional Patent Application No. 61/750,619, filed Jan. 9, 2013, both of which are incorporated herein by reference in their entirety.

### TECHNICAL FIELD

The present disclosure relates to computing devices for managing an online marketplace.

### BACKGROUND

Online marketplaces for supporting commerce between merchants and consumers have appeared in recent years. In these online marketplaces, a merchant typically seeks consumers to purchase its products and services by posting sales or other deals for viewing by consumers, and optionally, may additionally advertise its products and services over the online marketplace. However, consumers and merchants alike may desire an improved online marketplace that offers opportunities for consumers to leverage the online marketplace to initiate relevant purchasing experiences, as well as relevant potential sales opportunities for merchants.

### SUMMARY

Disclosed herein are systems and methods for managing consumer demand in an online marketplace.

In one aspect, a method for managing consumer initiated demand in an online marketplace comprises: receiving a first request for a product or service from a first consumer; identifying one of a plurality of categories as corresponding to the first request; assigning the first request to the identified category; receiving at least one additional request for a product or service from a second consumer and assigning the at least one additional request to the identified category; determining, using a processor, a demand for the identified category based at least on the number of requests assigned to the identified category; and selectively generating a merchant notification for at least one merchant based on the determined demand for the identified category.

In another aspect, an apparatus for managing consumer demand in an online marketplace comprises: a memory; and a processor configured to execute instructions stored in the memory to: receive a first request for a product or service from a first consumer; identify one of a plurality of categories as corresponding to the first request; assign the first request to the identified category; receive at least one additional request for a product or service from a second consumer and assigning the at least one additional request to the identified category; determine a demand for the identified category based at least on the number of requests assigned to the identified category; and selectively generate a merchant notification for at least one merchant based on the determined demand for the identified category.

In yet another aspect, a method for managing consumer initiated demand in an online marketplace comprises receiving a first request for a product or service from a first consumer over a network, and, using a processor: comparing the first request against a database organized at least partially according to a plurality of categories, identifying one of a plurality of categories as corresponding to the first request based on the comparison, assigning the first request to the identified category, and receiving at least one additional request from a second consumer and assigning the at least one additional request for a product or service to the identified category.

These and other aspects will be described in additional detail below.

### BRIEF DESCRIPTION OF THE DRAWINGS

The various features, advantages and other uses of the present systems and methods will become more apparent by referring to the following detailed description and drawings in which:

FIG. 1 is a block diagram showing an example of an online marketplace;

FIG. 2 is a block diagram showing an example of a computing device for managing consumer demand for products in the online marketplace;

FIGS. 3A and 3B together are a flowchart depicting operations for initiating a demand for a product in the online marketplace;

FIG. 4 shows an exemplary product matching database for storing descriptions of products offered by merchants in the online marketplace;

FIG. 5 shows an exemplary data structure for storing information concerning demand for products in the online marketplace;

FIGS. 6A and 6B together are a flowchart depicting operations for notifying merchants of demand relating to a demand case and for facilitating offers from merchants to consumers;

FIG. 7 is a flowchart depicting operations for handing counteroffers and operations for renewing or terminating a demand case; and

FIG. 8 is a flowchart depicting operations for facilitating offers from merchants to consumers based upon the consumer's location.

### DETAILED DESCRIPTION

The embodiments described herein present an online marketplace that can manage demand from consumers for a product or service, can use social networks to aggregate demand for that product or service and can notify prospective merchants of the aggregated demand when appropriate.

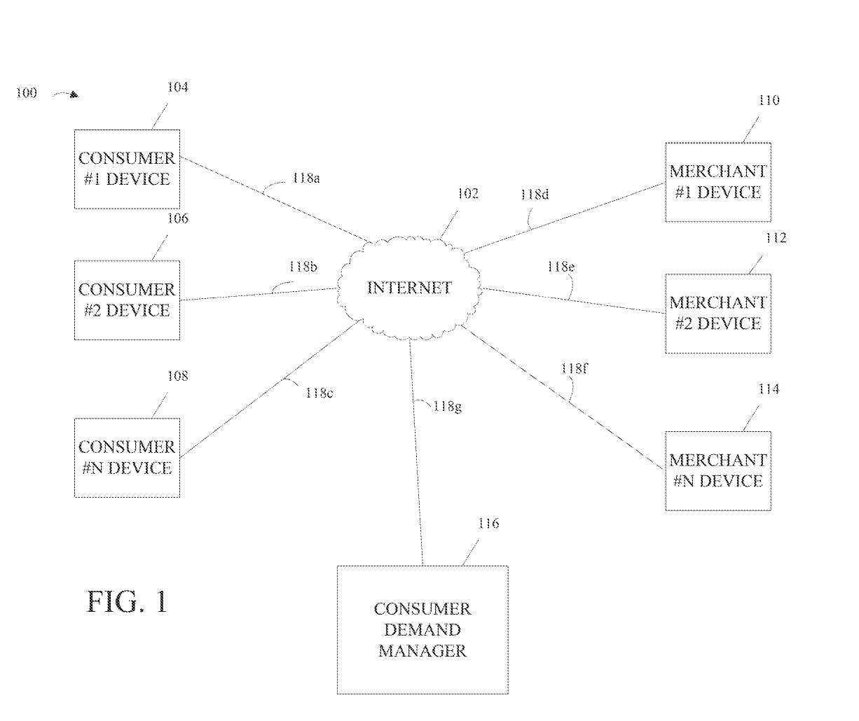

FIG. 1 is a block diagram showing an example of an online marketplace 100. The online marketplace 100 includes a communications network 102 allowing for communication among one or more consumer devices 104, 106 and 108, one or more merchant devices 110, 112 and 114, and a consumer demand manager 116. The communications network 102 can be a computer communications network that allows for sharing of information, data and/or computing resources. The exemplary communications network 102 is web-based, although other communications networks known to those skilled in the art could also be used. The consumer devices 104, 106 and 108, merchant devices 110, 112 and 114, and the consumer demand manager 116 communicate over the communications network 102 through network channels 118a-g. The network channels 118a-g can include wired and/or wireless channels, for example, using any industry standard or proprietary protocol.

Any number of consumers can interact with the online marketplace 100 through consumer devices 104, 106 and 108. Similarly, any number of merchants can interact with the online marketplace 100 through merchant devices 110, 112 and 114. A merchant could be any entity that offers products or services, and a consumer could be any entity that generally desires to consume such products or services. As described herein, “merchants” and “consumers” can be persons, groups of persons, businesses, organizations or government agencies, or any collection or combination thereof.

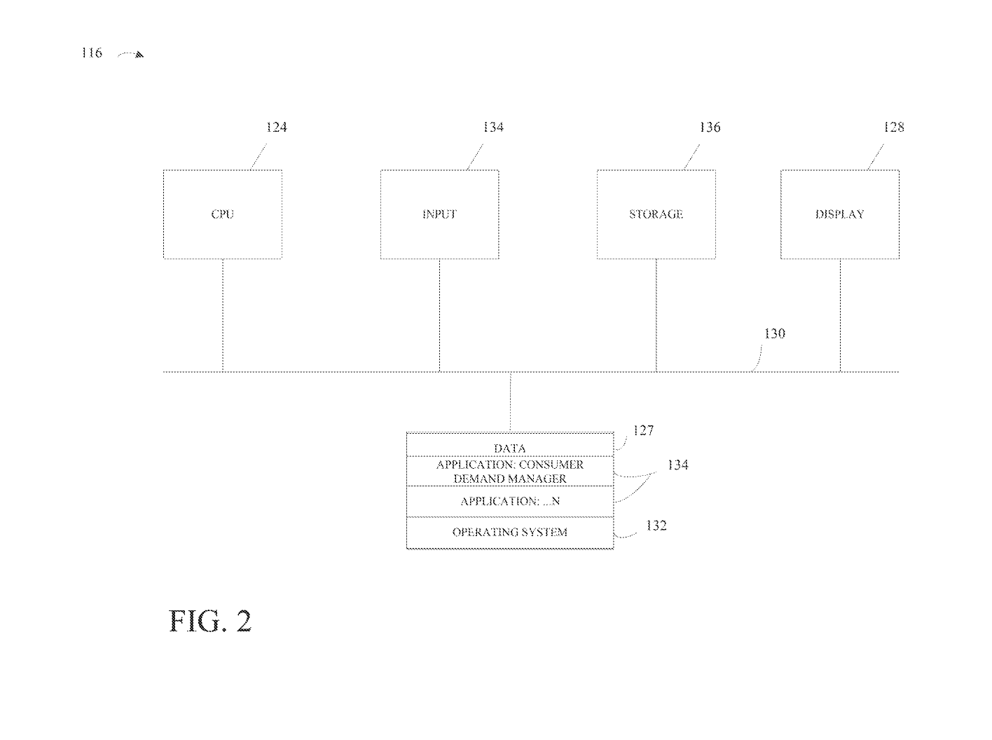

A consumer demand manager 116 is provided in communication with the online marketplace 100. FIG. 2 is a block diagram of an exemplary hardware configuration for the consumer demand manager 116. Although the exemplary hardware configuration is explained with reference to the consumer demand manager 116, the consumer devices 104, 106 and 108, and the merchant devices 110, 112 and 114, can each be implemented using the same or similar hardware configurations. The consumer demand manager 116 can be in the form of a computing system including multiple computing devices, or in the form of a single computing device, for example, a mobile phone, a tablet computer, a laptop computer, a notebook computer, a desktop computer, a server, and the like.

The CPU 124 in the consumer demand manager 116 can be a conventional central processing unit. Alternatively, the CPU 124 can be any other type of device, or multiple devices, capable of manipulating or processing information now-existing or hereafter developed. Although the disclosed embodiments can be practiced with a single processor as shown, e.g. CPU 124, advantages in speed and efficiency can be achieved using more than one processor.

The memory 126 in the consumer demand manager 116 can be a random access memory device (RAM). Any other suitable type of storage device can be used as the memory 126. The memory 126 can include code and data 127 that is accessed by the CPU 124 using a bus 130. The memory 126 can further include an operating system 132 and application programs 134, the application programs 134 including programs that permit the CPU 124 to perform the methods described herein. For example, the application programs 134 can include applications 1 through N which further include a consumer demand management application that performs the methods described herein.

Secondary storage 136 can be optionally provided in the form of any suitable computer readable medium, such as a hard disc drive, a memory device, a flash drive or an optical drive. One or more input devices 138, such as a keyboard, a mouse, or a gesture sensitive input device, receive user inputs and can output signals or data indicative of the user inputs to the CPU 220. One or more output devices can be provided, such as a display device 128. The display 128 can be coupled to the CPU 124 via the bus 130. The display device 128 allows output to be presented to a user. Other output devices that permit a user to program or otherwise use the consumer demand manager 116 can be provided in addition to or as an alternative to the display 128. When the output device is or includes a display, the display can be implemented in various ways, including by a liquid crystal display (LCD) or a cathode-ray tube (CRT) or light emitting diode (LED) display, such as an OLED display.

Although FIG. 2 depicts the CPU 124 and the memory 126 of the consumer demand manager 116 as being integrated into a single unit, other configurations can be utilized. The operations of the CPU 124 can be distributed across multiple machines (each machine having one or more of processors) which can be coupled directly or across a local area or other network. The memory 126 can be distributed across multiple machines such as network-based memory or memory in multiple machines performing the operations of the consumer demand manager 116. Although depicted here as a single bus, the bus 130 of the consumer demand manager 116 can be composed of multiple buses. Further, the secondary storage 136 can be directly coupled to the other components of the consumer demand manager 116 or can be accessed via a network and can comprise a single integrated unit such as a memory card or multiple units such as multiple memory cards. The consumer demand manager 116 can thus be implemented in a wide variety of configurations.

The illustrated online marketplace 100 having the consumer demand manager 116 can be utilized by one or more consumers contemplating or desiring an acquisition of products or services offered by a merchant to obtain an advantaged purchasing opportunity with respect to such products or services. The online marketplace 100 is a “live” marketplace, permitting interaction between consumers, and between consumers and merchants, for example. The description that follows refers primarily to a singular “product” for clarity, although it will be understood that this term, as used herein, is also inclusive of multiple products, of one or multiple services, or of any other items generally renderable in commerce.

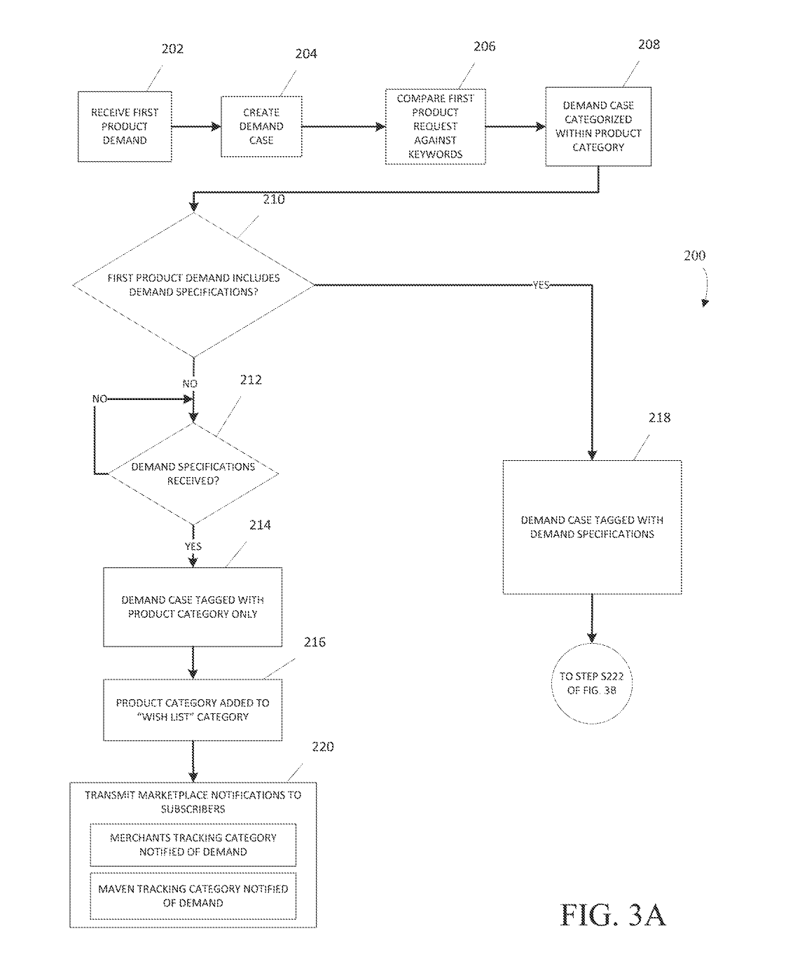

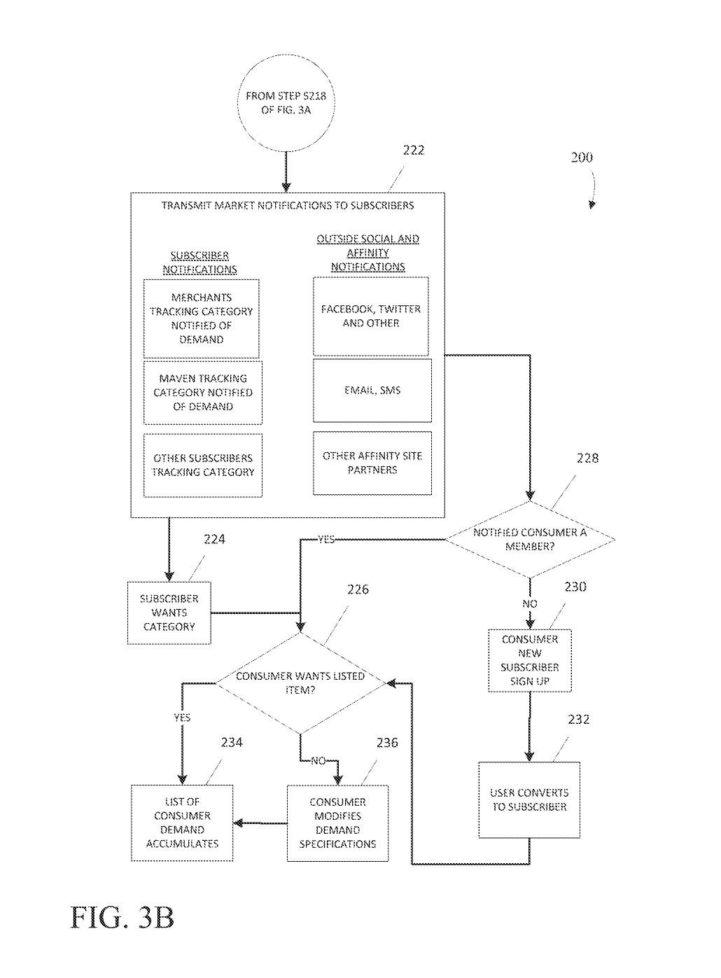

An exemplary process 200 for initiating a demand for a product in the online marketplace 100 will be described with reference to FIGS. 3A and 3B. The operations described in connection with the process 200 can be performed by the consumer demand manager 116. The process 200 can be embodied in the form of computer executable program instructions that are stored on a non-transitory computer readable medium such as the memory 126 of the consumer demand manager 116 that, when executed by a processor, such as the CPU 124 of the consumer demand manager 116, causes the processor to perform the operations that will be described herein with reference to the process 200.

As shown in FIGS. 3A and 3B, the consumer demand manager 116 is configured to receive a first product demand from a consumer in operation 202. A product demand, or request, is a general expression by a consumer that it desires to purchase a particular product via the online market place 100, and/or that the consumer may be interested in purchasing a particular product if an attractive purchasing opportunity was presented. The product demand can exemplify a purchase requirement of the consumer, for example, or can correspond to a general desire by the consumer to purchase the product. Receiving the first product demand can occur in any suitable manner, such as receiving by transmission over the communications network 102, and can be a result of direct communication or indirect communication from a consumer device 104, 106 or 108 operated by the consumer.

After the first product demand is received in operation 202, a new demand case is created by the consumer demand manager 116 in operation 204 based upon the first product demand. In operation 206, the first product request is compared against keywords in an effort to match the demand case created in operation 204 with a particular product offered by a merchant in the online marketplace 100.

The matching of the demand case created in operation 204 to a particular product is performed in relation to attributes of the first product demand received by the consumer demand manager 116. For example, the first product demand can be entered as a text string by the consumer into a consumer device 104, 106 or 108 for communication to the consumer demand manager 116. The text string can then be matched by the consumer demand manager 116 to description of a product offered by a merchant in the online marketplace 100 that is stored in the memory 126 and/or the secondary storage 136 of the consumer demand manager 116. The consumer demand manager 116 can be configured to dynamically match the text string to a description of a product, for example, as the text string is communicated to the consumer demand manager 116.

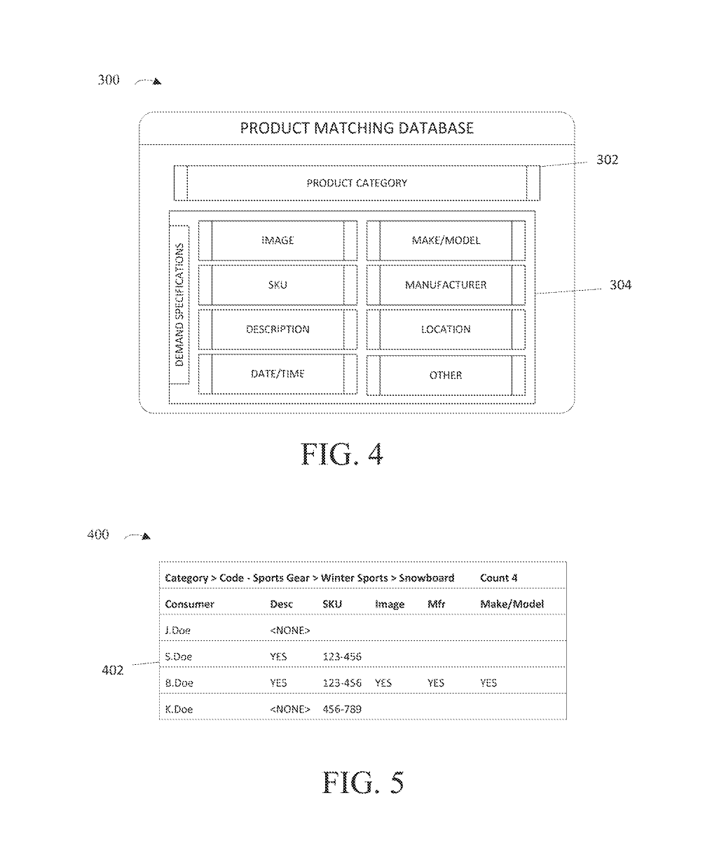

An example of a product matching database 300 for storing descriptions of products offered by merchants in the online marketplace 100 is represented in FIG. 4. The product matching database 300 can generally store keywords that are representative of particular products offered in the online market place 100. The consumer demand manager 116 is configured to dynamically compare the first product demand received in operation 202 against these keywords in order to match the new demand case to a particular product offered by a merchant in the online marketplace 100.

In some implementations, the keywords can be words, phrases and/or characters, or combinations thereof, which are descriptive or representative of particular products offered in the online market place 100. However, the additional and/or alternative keywords could be used for comparison against the first product demand. For example, the keywords could be configured for comparison against a visual, audio and/or audiovisual first product demand.

Keywords can be stored in one or more segments of the product matching database 300. As shown in FIG. 4, lists of keywords stored in the product database 300 can be organized by product category 302. The keywords stored in the product database 300 can further include any number of demand specifications 304. The product categories 302 are generally descriptive of a category of products offered in the online market place 100, while the demand specifications 304 can be any number or more specific sub-categories corresponding more particularly to a product offered in the online market place 100. Demand specifications 304 can include one or more descriptors of a particular product, including without limitation images, SKUs, descriptions, date/times, make/model information, manufacturer information, or a location for the product.

The structure of the product database 300 is illustrated as hierarchal, with parent product categories 302 and child demand specifications 304. However, other one-to-many relationships known to those skilled in the art could also be used. The product database 300 could alternatively have a horizontal structure implementing a many-to-many relationship, for example.

The consumer demand manager 116 also has features for standardizing a demand case. In addition to the keywords, the product database 300 can store standardized product codes, or base codes. These standardized product codes can be proprietary to the consumer demand manager 116, or can be industry standard product codes as may be found within the United Nations Standard Products and Services Code, The North American Product Classification System (NAPCS), Central Product Classification, or the Harmonized Commodity Description and Coding System, for example. These standardized product codes can be aligned with the keywords in the product database 300, such that the consumer demand manager 116 can identify a demand case with a standardized product code.

In operation 208, the consumer demand manager 116 compares the first product demand to the keywords stored in the product database 300 in order to categorize the demand case within a product category 302.

In operation 210, the consumer demand manager 116 determines whether the first product demand conveys sufficient information to match the demand case with one or more demand specifications 304 within the product category 302 corresponding to a particular product offered in the online market place 100. If the first product demand does not include demand specifications 304, then the consumer demand manager 116 my prompt the consumer who expressed the first product demand to add demand specification 304 to the first product demand. In operation 212, the consumer demand manager 116 determines whether any demand specification 304 have been added to the first product demand and received by the consumer demand manager 116. If not, then the demand case is tagged only with a product category 302 in operation 214. In operation 216, the product category 302 can be added as a “wish-list” category for the consumer who expressed the first product demand.

If it is determined in operation 210 that the first product demand conveys sufficient information to match the demand case with one or more demand specifications 304, then the demand case is tagged with the demand specifications 304 in operation 218.

The consumer demand manager 116 is generally configured to trigger outbound communications based upon activities within the online marketplace 100. For example, the consumer demand manager 116 can transmit marketplace notifications following operations 216 and 218 corresponding to the creation of the new demand case. Transmission of these marketplace notifications can occur in any suitable manner, such as transmitting by transmission over the communications network 102, and can be a result of direct communication or indirect communication to a consumer device 104, 106 or 108 operated by a consumer, or of direct communication or indirect communication to a merchant device 110, 112 or 114 operated by a merchant.

The consumer demand manager 116 can operate to transmit marketplace notifications based upon marketplace notification rules for various users of the online marketplace 100. For example, transmission of marketplace notifications can be based upon personalized notification rules established by a consumer or a merchant participating in the online marketplace 100, or can be based upon personalized notification rules for external users of the online marketplace 100, such as potential consumers or merchants of the online marketplace 100.

In operation 220, the consumer demand manager 116 transmits marketplace notifications related to the creation of a demand case that is tagged only with a product category 302. These marketplace notifications can be generally directed to users of the online marketplace 100 that have some association with, or interest in demand cases falling within the product category 302. For instance, these marketplace notifications can be directed toward certain subscribers of the consumer demand manager 116. In one implementation, for example, a marketplace notification related to the creation of a demand case that is tagged only with a product category 302 can be transmitted to merchants tracking that product category 302, such that those merchants are notified of the demand case falling within the product category 302. Further, for example, a similar marketplace notification can be transmitted to mavens tracking that product category 302, such that those mavens are notified of the demand case falling within the product category 302.

In operation 222, the consumer demand manager 116 transmits marketplace notifications related to the creation of a demand case that is tagged with a product category 302 and at least one demand specification 304. Similar to the marketplace notifications transmitted in operation 220, these marketplace notifications can be generally directed to users of the online marketplace 100 that have some association with, or interest in demand cases falling within the product category 302. For instance, these marketplace notifications can be directed toward certain subscribers of the consumer demand manager 116. In one implementation, for example, a marketplace notification related to the creation of a demand case that is tagged with a demand specification 304 can be transmitted to merchants tracking the product category 302 corresponding to the demand specification 304, such that those merchants are notified of the demand case tagged with a demand specification 304 falling within the product category 302. Further, for example, a similar marketplace notification can be transmitted to mavens or other subscribers tracking that product category 302 corresponding to the demand specification 304, such that those mavens are notified of the demand case tagged with a demand specification 304 falling within the product category 302.

The consumer demand manager 116 can include features for increasing the efficiency of the online marketplace 100 from the standpoint of consumers and/or merchants. The consumer demand manager 116 can function to ensure that market notifications are generally relevant to users of the online marketplace 100. For example, users of the online marketplace 100 can tailor preferences with respect to the marketplace notifications transmitted in operations 220 and 222. That is, under either operation 220 or 222, the consumer demand manager 116 can generally permit filtering of marketplace notifications. For example, a merchant may be permitted to instruct the consumer demand manager 116 to transmit marketplace notifications to the merchant based upon factors such as the age group of the consumer(s) within the demand case, the locale of such consumers, or based upon any other demographic information accessible to the consumer demand manager 116. This demographic information can be included in a product request, for example, or could be gathered from social media or other online networks. Similarly, a consumer may be permitted to instruct the consumer demand manager 116 to transmit marketplace notifications to the merchant based upon the particular product corresponding to a demand case. For example, a consumer may wish to be notified of demand case relating to a certain brand of product.

The consumer demand manager 116 can additionally be configured to transmit marketplace notifications based upon activities within the online marketplace 100 other than those corresponding to the creation of the new demand case. For example, marketplace notifications can be transmitted when a demand case is updated or terminated.

The marketplace notifications transmitted in operation 222 can be further directed more generally to the public via, for example, various connected social media and other online networks. As will be apparent from the description that follows, consumers can utilize the consumer demand manager 116 to promote the demand case created in operation 204, and generate a potential to earn financial rewards for actions that result in other consumers joining the demand case, and/or for actions that result in the recruitment of additional merchants to the online marketplace 100. Consumers utilizing the consumer demand manager 116 can thereby initiate and create outcomes such as highly relevant purchasing experiences for consumers, as well as highly relevant potential sales opportunities for merchants.

The consumer demand manager 116 can include features for rewarding certain activities in the online marketplace 100. For example, a “gamification” feature can be implemented whereby consumers can gain points or credits for taking actions that generally provide value to the online marketplace 100 and/or the users of the online marketplace 100. For example, if a consumer takes action to recruit a merchant to respond to a demand case, as described below, consumer rewards can be reflected in an account maintained by the consumer demand manager 116, and such consumer rewards can be used for purchases within the online marketplace 100. The consumer demand manager 116 could further implement a feature whereby a consumer is recognized within the online marketplace as particularly knowledgeable, influential and/or active with respect to the online marketplace 100. In this feature, for example, the consumer demand manager 116 can measure and generally tout a consumer's ability to engage other users of the online marketplace 100 and drive them to action with respect to the online marketplace 100.

Generally, consumers can earn financial rewards in the online marketplace 100 by leveraging the consumer demand manager 116 such that it operates to transmit marketplace notifications as described in reference to operation 222. In operation 222, a marketplace notification related to the creation of a demand case that is tagged with a demand specification 304 can be transmitted to consumers through connected social media and other online networks, as well as through other affinity partners of the consumer demand manager 116. These marketplace notifications can be transmitted to consumers via social media including without limitation Facebook, Twitter, LinkedIn and other social media. Similarly, these marketplace notifications can be transmitted to consumers via online networks including without limitation email, sms, telephony, mobile alerts, and other networks supported by the consumer demand manager 116 and/or affinity partners of the consumer demand manager 116. In one implementation, the consumer demand manager 116 can transmit marketplace notifications within a user section of the online marketplace 100 operated by the consumer demand manager 116.

The consumer demand manager 116 can function such that a demand case corresponding to these marketplace notifications has a data encoding structure that generally facilitates transport of the demand case between and within the connected social media and other online networks described above. For example, a demand case can have a data encoding structure that includes a unique identifier that can be used to transport the demand case across a plurality of social networks such as Facebook, Twitter and LinkedIn. Additionally, the demand case can have a data encoding structure that includes a unique identifier encoded with a unique structure, such as a Twitter hashtag, for example, such that the demand case can be distributed throughout a target social media network.

When a marketplace notification related to the creation of a demand case that is tagged with a demand specification 304 is transmitted to consumers, the consumer demand manager 116 permits such consumers to express their demand for the demand case. Consumers may, for example, be permitted to join the demand case as a way to express their demand for the demand case. As consumers express demand for a demand case, the demand case is aggregated. For example, each consumer that expresses a demand for the demand case can be tallied as a new member of the demand case. The consumer demand manager 116 can maintain a running count of the total consumers matched to the demand case, and increment the demand case consumer counter accordingly as new consumers express a demand for the demand case.

The consumer demand manager 116 can include specific features for administering the online marketplace 100, as described below, after transmission of marketplace notifications in operation 222.

In operation 224, the consumer demand manager 116 determines that certain subscribers of the consumer demand manager 116 who received marketplace notifications following transmission thereof in operation 222 are identified as generally wanting products offered in the online marketplace 100 within the product category 302 tagged in the demand case. In operation 226, the consumer demand manager 116 determines whether these subscribers have expressed a demand for the demand case, and therefore generally want a product having the demand specification 304 tagged in the demand case.

Other consumers who received marketplace notifications following transmission thereof in operation 222 are permitted to express their demand for the demand case. In operation 228, the consumer demand manager 116 determines whether a consumer who expresses demand for the demand case is a member of the online marketplace 100 managed by consumer demand manager 116. If not, the consumer demand manager 116 can transmit a prompt to the consumer to sign up as a subscriber of the consumer demand manager 116 in operation 230. In operation 232, the consumer demand manager 116 determines that the consumer has signed up as a subscriber of the consumer demand manager 116, and proceeds to operation 226. If, in operation 228, the consumer demand manager 116 determines that the consumer is a subscriber of the consumer demand manager 116, the consumer demand manager 116 also proceeds to operation 226. In operation 226, the consumer demand manager 116 determines whether these subscribers have expressed a demand for the demand case, and therefore generally want a product having the demand specification 304 tagged in the demand case.

If, in operation 226, the consumer demand manager 116 determines that a subscriber does not generally want a product having the demand specification 304 tagged in the demand case, the consumer demand manager 116 can transmit a prompt to the consumer modify one or more demand specifications 304. If the consumer demand manager 116 thereafter receives an expression from the subscriber of a demand for the demand case in operation 236, the consumer demand manager 116 proceeds to operation 234. In operation 234, all of the consumers who expressed a demand for the demand case are added to the running count of the total consumers matched to the demand case by the consumer demand manager 116. In addition to the foregoing, it is contemplated that the demand for the demand case can be expressed by a consumer when the consumer demand manager 116 receives a product demand in operation 202 that corresponds to an existing and active demand case, and that such consumers can also be added to the running count of the total consumers matched to the demand case.

The consumer demand manager 116 can have features for dynamic communication with a consumer through consumer devices 104, 106 or 108. For example, if the first product demand expressed by a consumer cannot be matched to keywords corresponding to a product category 302 and/or one or more demand specifications 304, the consumer could, for example, be allowed to request that keywords corresponding to the first product demand be added to the keywords stored in the product database 300. Similarly, if a consumer subsequent product demand expressed by a consumer cannot be matched to an existing active demand case that the consumer desires to join, the consumer could, for example, be allowed to request appropriate updates to the product database 300.

The consumer demand manager 116 may permit further interaction with consumers. For example, the consumer demand manager 116 may allow consumers to interact with product descriptions that are tagged to a demand case. In one implementation, the consumer may view the keywords tagged to a demand case, including, for example, the product category 302 descriptors and the demand specifications 304 stored in the product matching database 300, and may further view any base codes tagged to the demand case. If the consumer finds that the keywords tagged to a demand case by the consumer demand manager 116 do not accurately classify the demand case, the consumer can request one or more other or additional keywords be tagged to the demand case. Similarly, if the consumer finds that a base code tagged to a demand case by the consumer demand manager 116 does not accurately classify the demand case, the consumer can request one or more other or additional base codes be tagged to the demand case. The consumer may, for example be permitted to request for keywords to be aligned to new base codes, to suggest new base codes or to change the matching of keywords to base codes.

The consumer demand manager 116 may thereby allow users of the consumer demand manager 116 to create and dynamically grow the list of keywords and base codes, as well as modify the alignment between base codes and keywords. In each case described above, any request from a consumer can be routed to an administrator of the consumer demand manager 116 to review and approve any suggested changes.

An exemplary data structure 400 for storing information concerning demand for products in the online marketplace 100 is shown in FIG. 5. The exemplary data structure 400 is illustrated as a consumer demand table 402 for storing information relating to a demand case. The consumer demand table 402 can be organized according to the keywords described above, and have options for storing information corresponding to a product category 302 and one or more demand specifications 304.

The consumer demand table 402 is generally populated during the process 300 illustrated in FIGS. 3A and 3B. The illustrated consumer demand table 402 includes a consumer column, and rows for storing information corresponding to product demands received from the consumers by the consumer demand manager 116 in operation 202, and information corresponding to expressions of demand for a demand case received by the consumer demand manager 116 in operation 234. The information stored in the consumer demand table 402 can, for example, be information extracted from one or more product demands as the product demands are identified as corresponding to a product category 302 alone, or are identified as corresponding to both a product category and one or more demand specifications 304. Additionally, the information stored in the consumer demand table 402 can be information obtained when a consumer expresses a demand for a demand case for a particular product. In this instance, the expressed demand will include information corresponding to both a product category and one or more demand specifications 304.

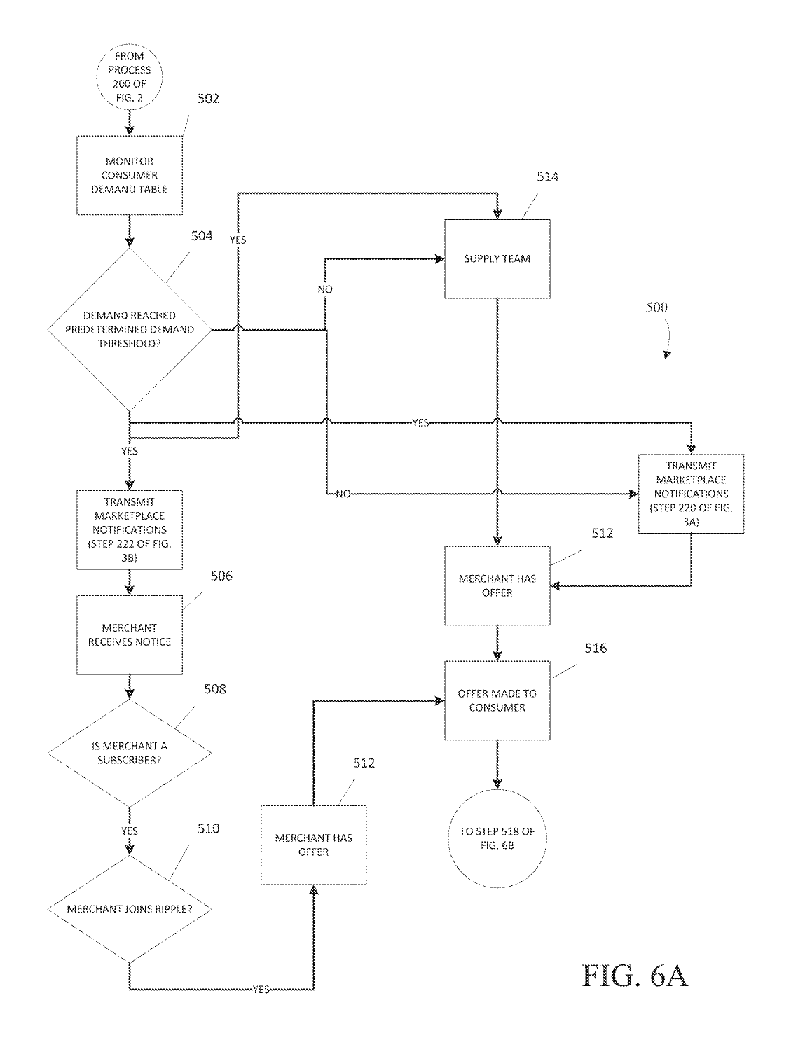

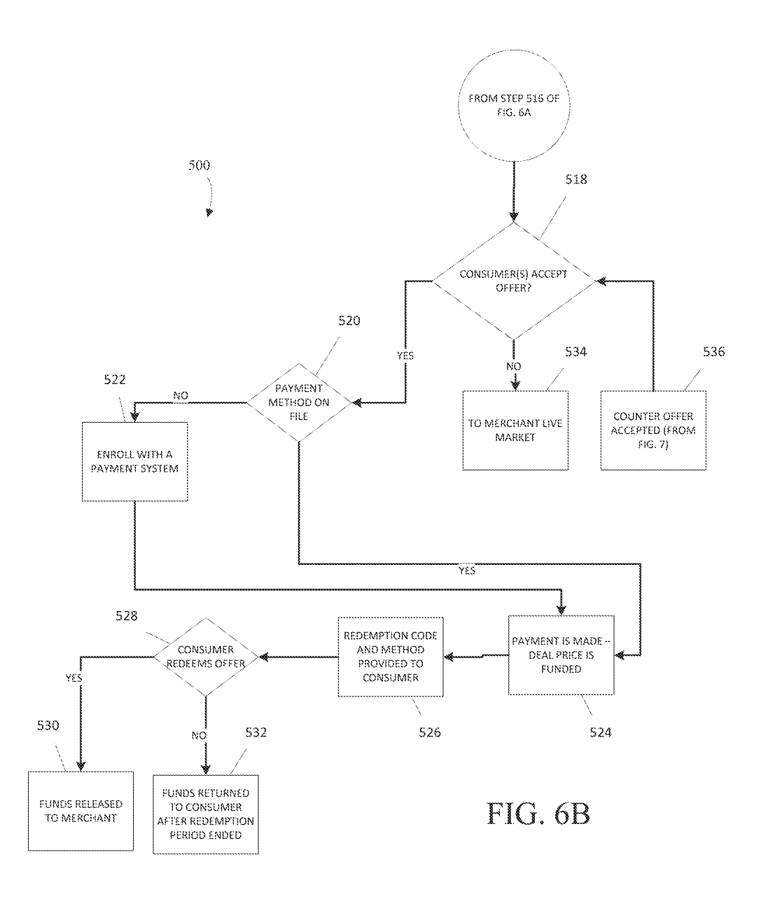

The consumer demand manager 116 can generally monitor a demand case, and can take action with respect to consumers and/or merchants of the online marketplace 100 when certain changes to the demand case occur. An exemplary process 500 for notifying merchants of demand relating to a demand case, and for facilitating offers from the merchants to consumers collected in the demand case will be described with reference to FIGS. 6A and 6B.

In the process 500, the consumer demand manager 116 generally monitors a demand case and takes action with respect to merchants when the demand case reaches a predetermined demand threshold. In the operation 502, the consumer demand manager 116 monitors changes in the consumer demand table 402 in response to the operation of the consumer demand manager 116 according to the process 200.

In operation 504, the consumer demand manager 116 determines whether demand for the demand case within a product category 302 has reached a predetermined demand threshold. In one implementation, a predetermined demand threshold is reached when the demand case includes a predetermined number of consumers who are associated with the demand case along with one or more demand specifications 304 corresponding to a particular product offered in the online market place 100. Although this is provided as a non-limiting example, it will be understood that the predetermined threshold could alternatively be reached when the demand case includes a predetermined number of consumers who are associated with the demand case within the product category 302, without the need for demand specifications 304 corresponding to a particular product. In another implementation, the predetermined demand threshold is specific to a merchant or group of merchants. For example, if a certain merchant indicates that it only wants to be notified if and when the demand case reaches a predetermined demand threshold (e.g., 20 consumers), the consumer demand manager 116 can operate to only transmit notifications upon satisfying this condition. However, other predetermined demand thresholds hold could correspond to any of the information included in the consumer demand table 402, either alone or in combination. Additionally, a predetermined demand threshold could implement algorithms including temporal components, for example. Merchants can also specify other conditions in addition to the threshold number of consumers. For example, some merchants may only want to be notified if there are a threshold number of consumers in a certain geographic region, age group or any other factor.

When the predetermined demand threshold is reached, the consumer demand manager 116 generally operates to notify merchants of the demand for the demand case according to the operations described below.

First, where the demand case is tagged with a product category 302 and at least one demand specification 304, marketplace notifications can be transmitted by the consumer demand manager 116 in accordance with operation 222. Because the marketplace notifications transmitted in operation 222 are directed generally to the public, there is a potential for a marketplace notification signifying the creation of a demand case that is tagged with a product category 302 and at least one demand specification 304 corresponding to a particular product offered in the online market place 100 to be transmitted to and received by a merchant. Thus, the merchant is notified of the demand for the demand case. In some instances, a merchant could also be notified of the demand for the demand case through communication with an administrator of the consumer demand manager 116.

In operation 508, the consumer demand manager 116 determines whether a merchant who is notified of the demand for the demand case is a subscriber of the online marketplace 100 managed by consumer demand manager 116. If not, the consumer demand manager 116 can transmit a prompt to the merchant to sign up as a merchant of the online marketplace 100 in operation 510. The consumer demand manager 116 can, for example, implement of process of validating that the merchant is trustworthy and credible before allowing the merchant to sign up as a merchant of the online marketplace 100. In operation 512, the consumer demand manager 116 permits the merchant to make an offer with respect to the demand case to consumers.

Second, marketplace notifications can be transmitted by the consumer demand manager 116 via communication from an administrator of the consumer demand manager 116 in accordance with operation 514. In operation 514, the administrator of the consumer demand manager 116 can evaluate the demand for the demand case and decide whether to instruct the consumer demand manager 116 to transmit a notification of the demand to a merchant. If a notification of the demand for the demand case is transmitted to a merchant by the consumer demand manager 116, the consumer demand manager 116 permits the merchant to make an offer with respect to the demand case to consumers in operation 512.

Finally, because the demand case is tagged with a product category 302, marketplace notifications can be transmitted by the consumer demand manager 116 in accordance with operation 220, thereby notifying a merchant of the demand for the demand case. Because these marketplace notifications are generally directed to existing subscribers of the online marketplace 100 managed by consumer demand manager 116, the process proceeds to operation 512, where the consumer demand manager 116 permits the merchant to make an offer with respect to the demand case to consumers.

In an alternative aspect of the process 500, when the predetermined demand threshold is not reached, the consumer demand manager 116 generally operates to notify merchants of the demand for the demand case according to the operations described below.

First, marketplace notifications can be transmitted by the consumer demand manager 116 via communication from an administrator of the consumer demand manager 116 in accordance with operation 514. In operation 514, the administrator of the consumer demand manager 116 can evaluate the demand for the demand case and decide whether to instruct the consumer demand manager 116 to transmit a notification of the demand to a merchant. If a notification of the demand for the demand case is transmitted to a merchant by the consumer demand manager 116, the consumer demand manager 116 permits the merchant to make an offer with respect to the demand case to consumers in operation 512.

Further, because the demand case is tagged with a product category 302, marketplace notifications can be transmitted by the consumer demand manager 116 in accordance with operation 220, thereby notifying a merchant of the demand for the demand case. However, as described above, because the demand case is tagged with a product category 302 only, these marketplace notifications can be subject to a merchant's preferences with respect to transmission of marketplace notifications. For example, the consumer demand manager 116 may be configured to account for merchant preferences such that a marketplace notification is only sent to the merchant if the merchant is tracking that product category 302. In this way, if desired, a merchant can control the consumer demand manager 116 to only transmit desired marketplace notifications relating to demand for specific demand cases.

Because these marketplace notifications are generally directed to existing subscribers of the online marketplace 100 managed by consumer demand manager 116, the process proceeds to operation 512, where the consumer demand manager 116 permits the merchant to make an offer with respect to the demand case to consumers.

As described above, a merchant can be notified of the demand for a demand case by receiving a marketplace notification transmitted by the consumer demand manager 116. In addition, a merchant could become aware of the demand for a demand case if a consumer in the online marketplace 100 suggests a merchant as a potential source to satisfy the demand. For example, a consumer could suggest a merchant by selecting the merchant from a merchant database listing qualified merchants. A consumer could also suggest a merchant not listed within the merchant database. For instance, the consumer could request that the consumer demand manager 116 transmit a notification of a demand for a demand case to a merchant. In this example, the consumer could include instructions for the consumer demand manager 116 to transmit the notification to the merchant, for example by providing contact information for the merchant. A consumer could also suggest a merchant by contacting the merchant through social media or other online networks. A merchant receiving a notification of the demand for a demand case can be provided with an internet link in the notification whereby the information regarding the demand case can be accessed and viewed.

In the implementations of the process 500 described above, the process 500 proceeds to operation 516 after the consumer demand manager 116 permits the merchant to make an offer with respect to the demand case to consumers in operation 512. A merchant may make an offer with respect to any demand case that the merchant is aware of, and can extend such an offer to all or some of the consumers collected in the demand case. An offer can specify, for example, one or more of a short title, a detailed description, a photo of a particular product corresponding to the demand case, a URL linking to information concerning the product, a cost or price, the retail value for the particular product, terms and conditions for the sale of the product with respect to consumers generally or with respect to specific consumers, and a date by which the offer can be redeemed by a consumer. It can be seen that an offer can specify information that can be matched to the keyword of the product database 300. Keywords are therefore scrubbed dynamically with alternative spelling suggestions as merchant offers are created.

A merchant offer may be made to a specific demand case or spread categorically to a number of demand cases that may align to product categories 302 and/or one or more demand specifications 304. Consumers may communicate dynamically within a demand case using an open wall that allows users, consumers and merchants, to exchange messages that may be viewed by all users viewing that demand case or may be made private between specific consumers in that demand case.

The consumer demand manager 116 can include features for generally rating a merchant, so that a consumer can be made aware of the credibility of a merchant within the online marketplace 100. For example, the consumer demand manager could inform a consumer of any ratings and/or feedback with respect to the merchant, or could inform a consumer with respect to the aspects of the merchants' activity in the online marketplace, including without limitations sales levels, prices or types of products offered.

Thereafter, the consumer demand manager 116 generally operates to complete a purchase of the product. In operation 518, the consumer demand manager 116 determines whether a consumer has accepted the offer made by the merchant in operation 512. If a consumer has accepted the offer made by the merchant in operation 512, the consumer demand manager 116 determines whether the consumer has a payment method on file in operation 520. If not, the consumer demand manager 116 can transmit a prompt to the consumer to enroll with a payment system in operation 522. If the consumer has a payment method on file, or if the consumer enrolls with a payment system in operation 522, the process proceeds to operation 524, where payment for the product is made and the deal price is funded.

In operation 526, the consumer demand manager 116 transmits a redemption code and redemption method to the consumer. In operation 528, the consumer demand manager 116 determines whether the consumer has redeemed the offer. If the offer has been redeemed, the consumer demand manager 116 releases the funds representing the deal price to the merchant in operation 530. If the offer has not been redeemed, in operation 532 the consumer demand manager 116 returns the funds representing the deal price to the consumer after a redemption period for redeeming the offer has ended.

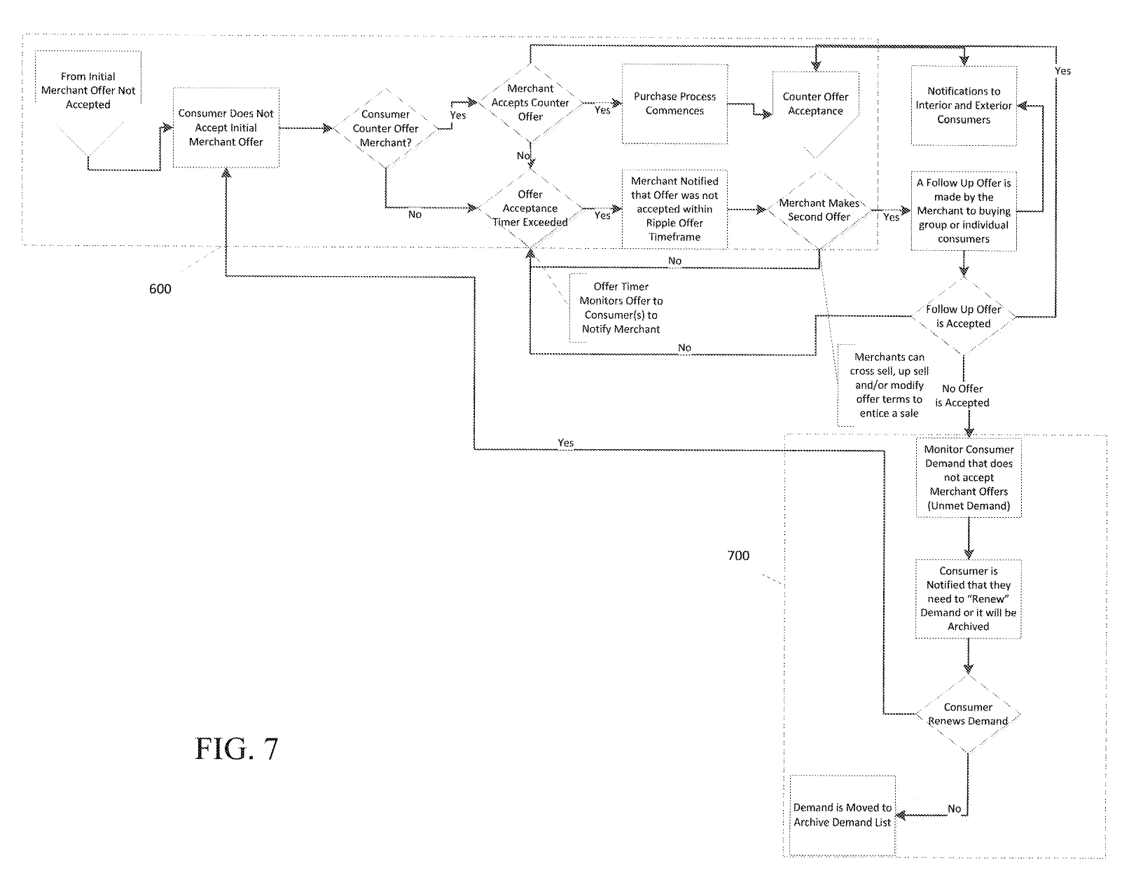

In operation 518, if the consumer demand manager 116 determines that a consumer has not accepted the offer made by the merchant in operation 512, the consumer demand manager 116 generally implements a process 600 shown in FIG. 7 wherein the consumer can submit a counteroffer. If a counter offer is accepted, the process proceeds to operation 518 described above. As shown, the process 600 can, for example, include temporal aspects whereby a second or follow-up offer can be made if an offer is not accepted within some timeframe set within the consumer demand manager 116. According to the process 600, the consumer demand manager promotes an interactive online marketplace 100 wherein consumers and merchants can negotiate terms of a purchase. In addition to permitting a merchant to lower the offer price for a demand case, it is also contemplated that a merchant could further be permitted to add value to a demand case. For example, a merchant could offer to add one or more products to the demand case that were not initially included in the demand case. In this way, a merchant can add value to the demand case without lowering the offer price. Additionally, the consumer demand manager 116 can be configured to transmit notifications of an acceptance of offer and/or follow-up offers.

As shown in FIG. 7, the consumer demand manager 116 can also implement a process 700 when no offer is accepted by a consumer. According to the process 700, the consumer demand manager 116 operates to monitor unmet demand within the online marketplace 100, and can further archive demand that is not renewed by one or more consumers. Further, the process 700 includes features whereby the consumer demand manager 116 operates renew demand. A demand can terminate by the complete fulfillment of all consumer demand within the demand case by accepted merchant offers, by expiration of the demand case over time when the consumer has not indicated a remaining interest in the demand, or through a combination thereof.

The consumer demand manager 116 can generally track the created and/or modified dates of a consumers demand cases, as well as the amount of time that has passed since the last modification date, and store the same as a “demand age.” The demand age has a threshold that presents older demand cases into a list for the consumer to renew their interest, cancel their demand or allow their demand to expire by passage of time. Any demand case that has demand age>=system threshold days to archive demand will be automatically removed from current demand cases and moved into an archived demand. Consumers may create a new demand case by activating an archived demand case. A demand case that is not archived is classified as “active.”

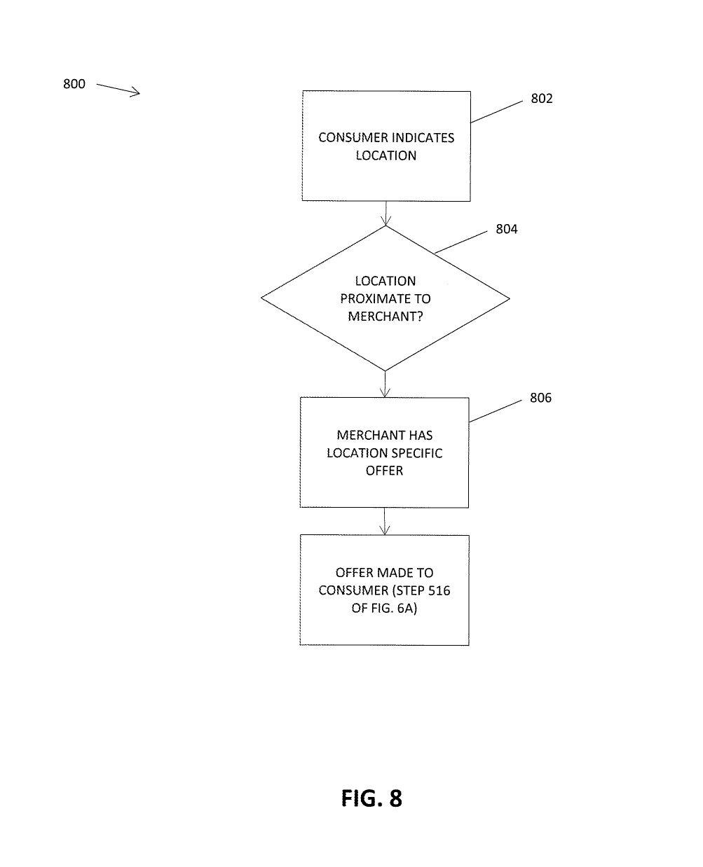

In addition to taking action with respect to consumers and/or merchants of the online marketplace 100 as certain changes to the demand case occur, as described above, the consumer demand manager 116 can take action in response to other circumstances that may be indicative of opportunities for advantageous purchasing experiences for consumers and/or potential sales opportunities for merchants. For example, an exemplary process 800 for facilitating offers from merchants to consumers based upon the consumer's location is shown in FIG. 8. The process 800 may have particular application, for instance, with respect to a retail merchant capable of rendering a product to a consumer located in the merchant's store.

In operation 802, a consumer indicates its location to the consumer demand manager 116. The consumer could indicate its current location in real time, for example. In one implementation, a consumer may indicate its current location as a result of direct communication or indirect communication from a GPS-enabled mobile consumer device 104, 106 or 108. With respect to the consumer device 104, 106 or 108, the indication of location may be active, at the behest of the consumer as it arrives at a merchant's location, or passive, where the indication of location may be automatically communicated to the consumer demand manager 116. In other implementations, a consumer may indicate an intention to be at a location in the near future.

Where it is determined in operation 804 that the consumer is located proximate a merchant's location, or may be in the future, the consumer demand manager 116 may function to permit the transmission of offers from that merchant to the consumer that relate, for example, to one or more products associated with product demands received from that consumer by the consumer demand manager 116. The associated products may be particular products where, for instance, the product demand has been identified as corresponding to both a product category 302 and one or more demand specifications 304, as well as other products related to the particular products. In addition, the associated products may be products relevant to a broader category (e.g., the consumer's “wish list” category) where the product demand is identified as corresponding to a product category 302 alone.

The transmission of an offer predicated upon the location of the consumer proximate the merchant, or the creation of the offer itself, may be conditioned upon various rules set up in the consumer demand manager 116.

For example, the presence of the consumer at the merchant's location may cause the consumer demand manager 116 to transmit a notification to the merchant of the presence of the consumer, identify the consumer to the merchant as a user of the consumer demand manager 116, inform the merchant of one or more of the consumer's product demands, and prompt the merchant to craft offers based on the product demands. The merchant can craft these offers in real time, for instance, and direct the consumer demand manager to transmit the offers to the consumer, which can be received by the consumer in-store via a mobile consumer device 104, 106 or 108. Alternatively, the transmission of an offer made according to the process 500 described above may be conditioned upon the presence of the consumer at the merchant's location. That is, the consumer demand manager 116 can delay transmission of an offer until the consumer to whom the offer is directed is located at the merchant's location.

It will be understood that other aspects of the consumer demand manager 116 may account for the location of a consumer. For example, the consumer demand manager 116 may operate to transmit marketplace notifications based upon rules that account for the presence of the consumer at the merchant's location. For instance, the merchant can tailor its preferences with respect to the online marketplace 100 so that market notifications are transmitted automatically when a consumer associated with a demand case is present at the merchant's location, or, the threshold for the demand case may generally be lower for in-store consumers.

If these or other optional conditions are satisfied, in operation 806, the consumer demand manager 116 permits the merchant to make an offer with respect to the demand case to the consumer, and the process 800 may generally proceed according to operation 516 of the process 500 as explained above. Consumers may therefore be advised of offers relevant to their desires while in-store at a merchant's location and can act to make a purchase on the offer in real time while in-store. In this example, it may be possible for the actual transaction following acceptance of an offer to occur outside of the administration of the online marketplace 100 by the consumer demand manager 116.

Other features of the consumer demand manager 116 are contemplated herein. For example, consumers may choose to create a “private” demand case, in which case they do not want their demand case exposed to other consumers. Further, a private demand case can be implemented if the consumer privately joins an existing demand case. Such private demand cases can be used by consumers to organize private groups of users that create their own closed demand case.

The consumer demand manager 116 may further permit certain levels of customization with respect to operations of the consumer demand manager 116 described above. For example, the consumer demand manager 116 can provide for personalization options for users of the consumer demand manager 116 with respect to matching of demand cases created by other users to the user's personal interests. A user's personal interest may correspond to, for example, joining a demand case as a consumer, or selling to consumers by making offers in the marketplace as a merchant. Further user personalization can manage, for example, marketplace notification preferences and/or default system behaviors.

The consumer demand manager 116 may allow one user to follow, with permission, another user of the online marketplace 100. Such a followed user may earn financial incentives for purchases they inherently lead their followers to make. The consumer demand manager 116 can suggest users for another user to follow which is based on available demographic information made available through social network systems such as Facebook and/or information provided explicitly by the user.

The online marketplace 100 presents a number of ways to identify interest through use of interest tags. These tags present generic descriptions of consumer or merchant areas of interest, such as ‘Nightlife’ or ‘Sports’, where such general interest tags are aligned through the product matching system to demand cases. The online marketplace 100 can create user tags based upon the behavior of users of the online marketplace 100. User tags can correspond, for example, to demand cases created, joined or viewed, merchant offers, users followed, activity, and demographic data from third party social network systems. The combination of all of the personalization methods listed herein are utilized by the marketplace to match consumers and suppliers to demand cases that most relate to their inherent and expressed interests.

The online marketplace 100 presents an opportunity for the consumer demand manager to collect information concerning activity within the online marketplace 100, such as information concerning aspects of product demand, aspects of purchases, and information related to consumers and/or merchants and their interactions with the online marketplace 100. This information can be collected and sold, for example, or otherwise implemented. It is contemplated that this information could be utilized, for example, to inform merchants with respect to how to effectively interact with the online marketplace 100 to encourage purchases by consumers at terms advantageous to the merchant.

The consumer demand manager 116 generally operates to attract consumers to the online marketplace 100, as well as track and organize consumer information relating demand for particular products offered in the online marketplace 100. By creating and updating demand cases, for example, the consumer demand manager 116 generally organizes consumers into categories of like demand. This ability to monitor demand presents opportunities for merchants to utilize the consumer demand manager 116 to implement systems tailored to specific demands, such as “just-in time” manufacturing, and to control inventory levels much better.

A merchant utilizing the consumer demand manager 116 can manufacture against specific demand in the online marketplace 100 and have confidence that the designs and specifications of a product being produced is in fact what consumers in the online marketplace 100 desire. Further, inventory controls can be better managed, and merchants can better manage quantities or units of raw goods to carry in the way of inventory as a result of being able to sell against real demand that is quantifiable and definable in much more specific and exact ways.

The consumer demand manager 116 could allow merchants to optimize their business models to generally be marketers and order-takers, and not have to carry inventory and have showrooms, etc., but rather simply drop-ship orders from transactions closed in the online marketplace 100.

The embodiments of the consumer demand manager 116, consumer devices 104, 106 and 108 and merchant devices 110, 112 and 114 (and the algorithms, methods, instructions etc. stored thereon and/or executed thereby) can be realized in hardware including, for example, intellectual property (IP) cores, application-specific integrated circuits (ASICs), programmable logic arrays, optical processors, programmable logic controllers, microcode, firmware, microcontrollers, servers, microprocessors, digital signal processors or any other suitable circuit. In the claims, the term “processor” should be understood as encompassing any the foregoing, either singly or in combination. The terms “signal” and “data” are used interchangeably. Further, portions of the consumer demand manager 116, consumer devices 104, 106 and 108 and merchant devices 110, 112 and 114 do not necessarily have to be implemented in the same manner.

In one embodiment, the consumer demand manager 116, consumer devices 104, 106 and 108 and merchant devices 110, 112 and 114 can be implemented using general purpose computers/processors with a computer program that, when executed, carries out any of the respective methods, algorithms and/or instructions described herein. In addition or alternatively, for example, special purpose computers/processors can be utilized which can contain other hardware for carrying out any of the methods, algorithms, or instructions described herein.

Further, all or a portion of embodiments of the present disclosure can take the form of a computer program product accessible from, for example, a non-transitory computer-usable or computer-readable medium. A non-transitory computer-usable or computer-readable medium can be any device that can, for example, tangibly contain, store, communicate, or transport the program for use by or in connection with any processor. The non-transitory medium can be, for example, an electronic, magnetic, optical, electromagnetic, or a semiconductor device. Other suitable mediums are also available.

While recited characteristics and conditions of the invention have been described in connection with certain embodiments, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A method for managing consumer initiated demand in an online marketplace, comprising:
receiving a first request for a product or service from a first consumer;
identifying one of a plurality of categories as corresponding to the first request;
assigning the first request to the identified category;
receiving at least one additional request for a product or service from a second consumer and assigning the at least one additional request to the identified category;
determining, using a processor, a demand for the identified category based at least on the number of requests assigned to the identified category; and
selectively generating a merchant notification for at least one merchant based on the determined demand for the identified category.

2. The method of claim 1, further comprising:
comparing the first request against a database organized at least partially according to the plurality of categories;
wherein one of the plurality of categories is identified as corresponding to the first request based on the comparison.

3. The method of claim 2, wherein the first request is a text string, and wherein the text string is compared against one or more keywords associated with the identified category in the database to identify one of the plurality of categories as corresponding to the first request.

4. The method of claim 1, further comprising:
identifying one of the plurality of categories as corresponding to the at least one additional request, wherein the identified category corresponding to the at least one additional request is the same as the identified category corresponding to the first request; and
assigning the at least one additional request to the identified category.

5. The method of claim 1, further comprising:
selectively generating a consumer notification for a plurality of consumers, the consumer notification inviting the plurality of consumers to each submit a request corresponding to the identified category;
receiving one or more requests from the plurality of consumers in response to the consumer notification; and
assigning the one or more requests request to the identified category.

6. The method of claim 5, wherein the consumer notification is generated through a social media network.

7. The method of claim 1, further comprising:
receiving an offer to sell a product or service within the identified category from a merchant in response to the merchant notification; and
generating an offer notification for at least one of the first consumer and the second consumer based on the received offer from the merchant.

8. The method of claim 1, wherein selectively generating the merchant notification comprises:
generating the merchant notification if the determined demand for the identified category is greater than a predetermined threshold; and
not generating the merchant notification if the determined demand for the identified category is less than a predetermined threshold.

9. The method of claim 8, wherein the predetermined threshold is based at least partially on a predetermined number of requests assigned to the identified category.

10. The method of claim 9, wherein each of the plurality of categories includes at least one demand specification, further comprising:
identifying if the first request includes information pertaining to the at least one demand specification of the identified category;
wherein determining, using the processor, the demand for the product category, comprises
increasing the demand for the identified category based on the first request only if the first request includes information pertaining to the at least one demand specification.

11. The method of claim 1, further comprising:
generating the merchant notification for at least one merchant based on a physical location of one of the first consumer and the second consumer.

12. The method of claim 1, wherein the identified category corresponds to a product or service.

13. The method of claim 1, wherein the identified category includes multiple related products or services.

14. An apparatus for managing consumer demand in an online marketplace, comprising:
a memory; and
a processor configured to execute instructions stored in the memory to:
receive a first request for a product or service from a first consumer;
identify one of a plurality of categories as corresponding to the first request; <assign the first request to the identified category;
receive at least one additional request for a product or service from a second consumer and assigning the at least one additional request to the identified category;
determine a demand for the identified category based at least on the number of requests assigned to the identified category; and
selectively generate a merchant notification for at least one merchant based on the determined demand for the identified category.

15. The apparatus of claim 14, wherein the processor is further configured to execute instructions stored in the memory to:
compare the first request against a database organized at least partially according to the plurality of categories;
wherein one of the plurality of categories is identified as corresponding to the first request based on the comparison.

16. The apparatus of claim 14, wherein the processor is further configured to execute instructions stored in the memory to:
generate the merchant notification if the determined demand for the identified category is greater than a predetermined threshold; and
not generate the merchant notification if the determined demand for the identified category is less than a predetermined threshold;
wherein the predetermined threshold is based at least partially on a predetermined number of requests assigned to the identified category.

17. A method for managing consumer initiated demand in an online marketplace, comprising:
receiving a first request for a product or service from a first consumer over a network, and, using a processor:
comparing the first request against a database organized at least partially according to a plurality of categories,
identifying one of a plurality of categories as corresponding to the first request based on the comparison,
assigning the first request to the identified category, and
receiving at least one additional request from a second consumer and assigning the at least one additional request for a product or service to the identified category.

18. The method of claim 17, wherein the first request is a text string, and wherein the text string is compared against one or more keywords associated with the identified category in the database to identify one of the plurality of categories as corresponding to the first request.

19. The method of claim 17, further comprising:
determining, using the processor, a demand for the identified category based at least on the number of requests assigned to the identified category; and
selectively generating a merchant notification for at least one merchant based on the determined demand for the identified category.

20. The method of claim 17, further comprising:
receiving an offer to sell a product or service within the identified category from a merchant in response to the merchant notification; and
generating an offer notification for at least one of the first consumer and the second consumer based on the received offer from the merchant.
